(19) United States
(12) Patent Application Publication
(10) Pub. No.: US 2011/0083036 A1
(43) Pub. Date: Apr. 7, 2011

(54) Method and System for Restoring a Server Interface for a Mobile Device

(75) Inventors: Kamil Pawlowski, Oakland, CA (US); William Warren Bjorge, Los Gatos, CA (US)

(73) Assignee: MOTOROLA, INC., Schaumburg, IL (US)

(21) Appl. No.: 12/898,004

(22) Filed: Oct. 5, 2010

Related U.S. Application Data
(60) Provisional application No. 61/249,119, filed on Oct. 6, 2009.
(60) Provisional application No. 61/249,249, filed on Oct. 6, 2009.

(51) Int. Cl. G06F 15/16; G06F 11/16

(52) U.S. Cl. 714/4.2; 709/217; 714/E11.054

(57) ABSTRACT

Methods of recovering data lost by a server, and/or facilitating a recovery of data lost by a server, as well as systems for recovering (and/or facilitating the recovery of) data lost by a server, are disclosed herein. In some embodiments, the method includes receiving a data map pertaining to the lost data from one or both of a second server (which can be, for example, a master server) and a mobile device, and obtaining application data from the data map. The method further includes, based upon the application data, accessing one or more of the first mobile device, a second mobile device and a content provider website to obtain at least some of the lost data. Instead, or in addition, the lost data can be obtained from one or more mobile devices or other devices. In some such embodiments, the process can be initiated or governed by the second (e.g., master) server or a mobile device.

### CROSS-REFERENCE TO RELATED APPLICATIONS

This application claims the benefit of each of U.S. Provisional Patent Application No. 61/249,119 and U.S. Provisional Patent Application No. 61/249,249, both of which are entitled “Method and System for Restoring a Server Interface for a Mobile Device” and were filed on Oct. 6, 2009, and both of which are hereby incorporated by reference herein.

### FIELD OF THE INVENTION

The present invention relates to data storage and, more particularly, to systems and methods that limit the loss of data when data storage system failures occur.

### BACKGROUND OF THE INVENTION

Computer-based servers, such as web servers, have been traditionally called upon to store various types of data. This data can originate from various sources, such as is generated by communications between mobile devices with the web servers and websites hosted by those servers, as well as with other mobile devices and other devices such as computer systems. Notwithstanding efforts to prevent failure, no web server or other computer-based server can be made entirely immune to failures. To reduce or minimize the negative consequences of such failures in terms of data loss, a variety of methods have been developed to prevent or at least limit the data that may be lost during failures.

One traditional method in this regard involves creating and storing a back-up of the data on an additional redundant server system (e.g., via tapes, CDs, database replication, or some other bulk copy methodology). Yet although this can be effective in mitigating data loss as a result of failures, this technique can also be costly, since the storing of a copy of all the data stored on a particular server can require extensive resources. Further, access to the stored back-up data is typically limited to select individuals and therefore attempts to access any lost data can be an arduous endeavor.

It would therefore be advantageous if an improved system and/or method of storing data could be developed that prevented or at least reduced, and/or mitigated the consequences of, data loss that might otherwise occur during failure of a server system.

### SUMMARY OF THE INVENTION

In at least one embodiment, the present invention relates to a method of recovering data lost by a first server. The method includes (a) receiving a data map pertaining to the lost data from at least one of a second server and a first mobile device, and (b) obtaining application data from the data map. The method further includes (c) based upon the application data, accessing one or more of the first mobile device, a second mobile device and a content provider website to obtain at least some of the lost data.

Additionally, in at least one additional embodiment, the present invention relates to a method of facilitating a recovery of data lost by a first server. The method includes (a) detecting a failure in the first server, and (b) taking an action that precipitates reassignment of a responsibility of the first server to a second server. The method also includes (c) causing transmission of a data map to the second server, whereby the transmission of the data map to the second server allows the second server to conduct additional communications by which the data lost by the first server is recovered by the second server.

Further, in at least one embodiment, the present invention relates to a system for recovering data lost by the first server upon an occurrence of a failure event. The system includes a second server having at least one interface by which the second server is able to communicate with one or more of a mobile device and a content provider website, and a third server in communication with the second server, wherein the third server stores a data map pertaining to the data. Upon receiving an indication of the occurrence of the failure event, the third server determines that the second server should store the data when recovered and then additionally provides the data map to the second server. Additionally, upon receiving the data map, the second server based upon the data map contacts the mobile device or the content provider website to obtain the data lost by the first server. In at least one other embodiment, the third server can be optional and all data can be recovered based on a data map provided by the mobile device to the second server.

### BRIEF DESCRIPTION OF THE DRAWINGS

FIG. 1 shows in schematic form an exemplary communication system involving one or more mobile devices that are in communication with one or more content provider websites by way of an intermediate web server, in accordance with at least one embodiment of the present invention;

FIG. 2 is a block diagram illustrating exemplary components of one of the mobile devices of FIG. 1;

FIG. 3 is a block diagram showing exemplary components of the web server of FIG. 1;

FIG. 4 is a flowchart showing various steps of a data recovery operation governed at least in part by the web server of FIG. 1, in accordance with at least one embodiment of the present invention; and

FIG. 5 is a flowchart showing various steps of an alternate data recovery operation governed at least in part by one of the mobile devices of FIG. 1, in accordance with at least one additional embodiment of the present invention.

### DETAILED DESCRIPTION OF THE INVENTION

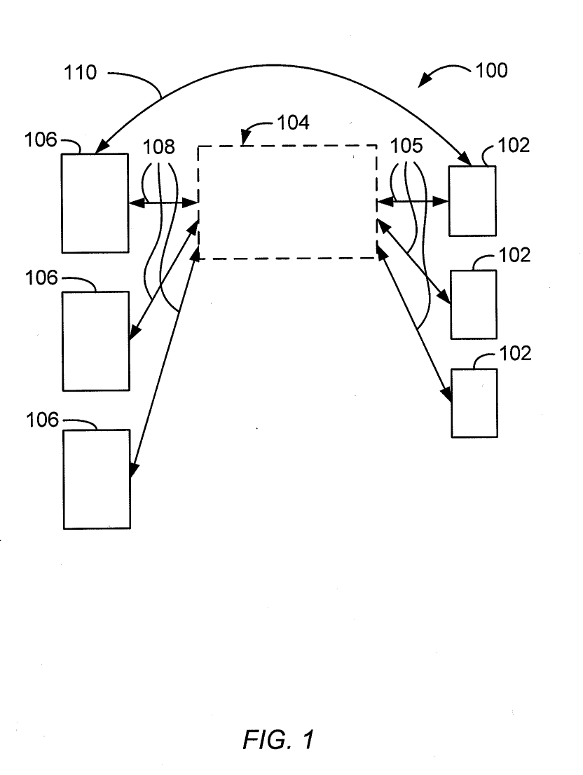

Referring to FIG. 1, a block diagram of an exemplary communications system 100 is shown in a simplified schematic form, in accordance with at least some embodiments of the present invention. As shown, the communications system 100 includes in this embodiment three mobile devices 102, each of which is shown to be in communication via a respective communication link 105 with a server interface, which in the present embodiment is a web server 104. The mobile devices 102 are respectively representative of communication devices operated by persons (or users) or possibly by other entities (e.g., computers) desiring or requiring communication capabilities. In some embodiments, for example, the mobile devices 102 can be any of cellular telephones, other wireless devices such as personal digital assistants, and/or devices such as laptops and desktop computers that are capable of connecting to and communicating with a network. The communications system 100 additionally is shown to include three content provider websites (CPWs) 106, such as social networking websites, each of which is shown to be in communication with the web server 104 via a respective communication link 108.

Although three of the mobile devices 102 and three of the CPWs 106 are shown in to be in communication with the web server 104, it will be understood that depending upon the time or operational circumstance any arbitrary number of mobile devices such as the mobile devices 102 can be in communication with the web server 104 and likewise any arbitrary number of CPWs such as the CPWs 106 can be in communication with the web server. For example, while at one time all three of the mobile devices 102 are in communication with the web server 104, at another time one or more of the mobile devices 102 may no longer be in communications with the web server and/or one or more other mobile devices may have entered into communications with the web server. Additionally, in other embodiments any arbitrary number of mobile devices such as the mobile device(s) 102 can be in communication with any arbitrary number of CPW(s) such as the CPWs 106 by way of direct communication links, one of which is shown as a link 110. That is, FIG. 1 is intended to be representative of any of a variety of systems employing any arbitrary number of mobile devices and any arbitrary number of CPWs that are in communication with one another either indirectly via a web server or directly with one another.

Depending upon the embodiment, the communication links 105, 108, 110 can be part of a single network or multiple networks, and each link can include one or more wired and/or wireless communication pathways, for example, landline (e.g., copper) wiring, optical fiber, microwave communication, radio channel, wireless path, intranet, internet, and/or World Wide Web communication pathways. In addition, a variety of communication protocols and methodologies can be used to conduct the communications via the communication links 105, 108, 110 between the mobile devices 102, web server 104, and CPWs 106, including for example, transmission control protocol/internet protocol (TCP/IP), extensible messaging and presence protocol (XMPP), file transfer protocol (FTP), etc. In other embodiments, other types of communication links for facilitating the transfer of signals between the plurality of mobile devices 102 and the CPWs 106 can be utilized as well. Although in the present embodiment the communication links/network and server are each discussed as being web-based, in other embodiments, the links/network and server can assume various non-web-based forms.

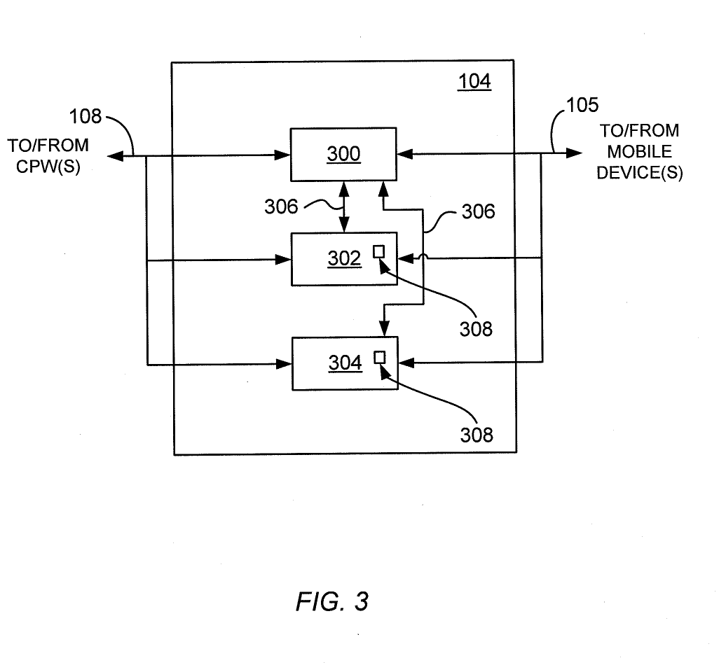

As will be discussed below in more detail with regard to FIGS. 3-5, the web server 104 is configured to serve as an intermediary between the mobile devices 102 and the CPWs 106. Various types of communications between the mobile devices 102 and CPWs 106 are passed through, processed by and/or monitored by the web server 104 including, for example, communications involving the uploading and downloading of files (e.g., photos, music, videos, text entries, etc.), blog postings, and messaging (e.g., short Message Service (SMS), Multimedia Messaging Service (MMS), and Instant Messaging (IM)). The CPWs 106 are generally intended to encompass a variety of interactive websites that allow for the downloading and uploading (e.g., posting) of various forms of data, such as personal and/or business information, pictures, videos, and songs and thereby facilitate the creation and maintaining of interpersonal connections among persons and groups of persons. Examples of CPWs include, for example, Facebook, MySpace, hi5, LinkedIn, Twitter. For purposes of the present invention, CPWs can also be understood to encompass various other types of websites (e.g., business-to-business or business-to-consumer websites) that, while not focused entirely or predominantly upon social networking, nevertheless also include social networking-type features.

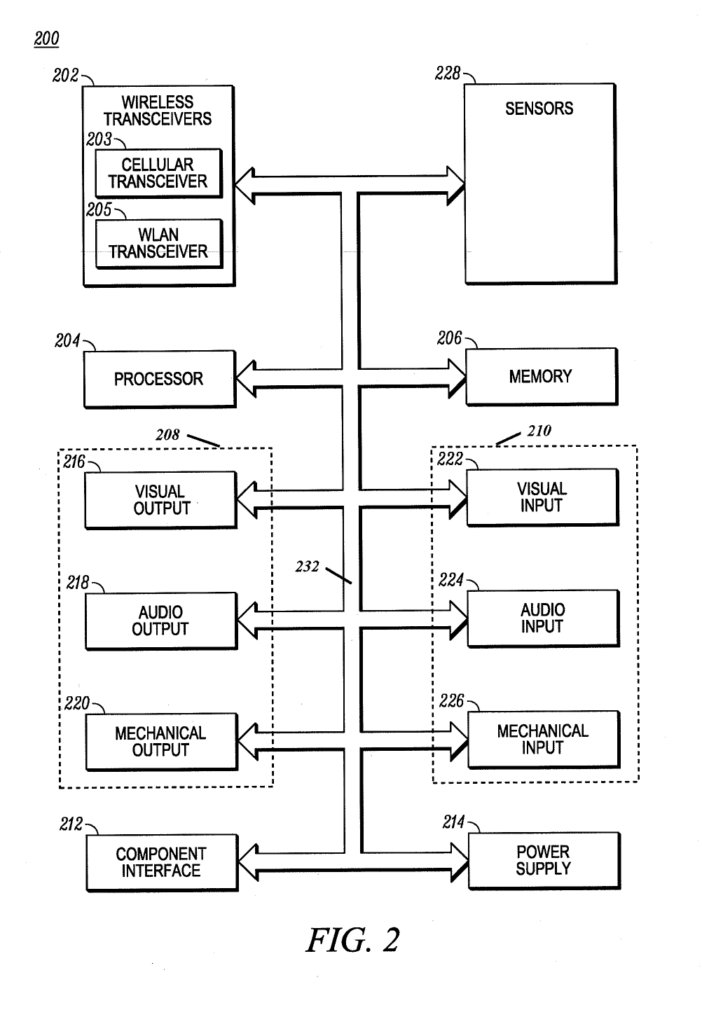

Referring to FIG. 2, there is provided a block diagram illustrating exemplary internal components 200 of a mobile device such as the mobile devices 102 in accordance with the present embodiment. As shown in FIG. 2, the components 200 include one or more wireless transceivers 202, 203, 205, a processor 204 (e.g., a microprocessor, microcomputer, application-specific integrated circuit, etc.), a memory portion 206, one or more output devices 208, and one or more input devices 210. In at least some embodiments, a user interface is present that comprises one or more of the output devices 208 and one or more of the input devices 210. The internal components 200 can further include a component interface 212 to provide a direct connection to auxiliary components or accessories for additional or enhanced functionality. The internal components 200 preferably also include a power supply 214, such as a battery, for providing power to the other internal components while enabling the mobile device to be portable. All of the internal components 200 can be coupled to one another, and in communication with one another, by way of one or more internal communication links 232 (e.g., an internal bus).

Each of the wireless transceivers 202 utilizes a wireless technology for communication, which can include for example (but are not limited to) cellular-based communication technologies such as analog communications (using AMPS), digital communications (using CDMA, TDMA, GSM, iDEN, GPRS, EDGE, etc.), and next generation communications (using UMTS, WCDMA, LTE, IEEE 802.16, etc.) or variants thereof, or peer-to-peer or ad hoc communication technologies such as HomeRF (radio frequency), Bluetooth and IEEE 802.11(a, b, g or n), or other wireless communication technologies such as infrared technology. In the present embodiment, the wireless transceivers 202 include a cellular transceiver 203 and a wireless local area network (WLAN) transceiver 205, although in other embodiments only one of these types of wireless transceivers (and possibly neither of these types of wireless transceivers, and/or other types of wireless transceivers) is present. By virtue of the use of the wireless transceivers 202, a mobile device such one of the mobile devices 102 is capable of communicating both with a CPW such as any of the CPWs 106 by way of a wireless communication link that allows for direct communications therebetween (e.g., such as the communication link 110), as well as capable of communicating with the web server 104 (and thus indirectly again with any of the CPWs 106) by way of a communication link such as one of the communication links 105.

Exemplary operation of the wireless transceivers 202 in conjunction with others of the internal components 200 can take a variety of forms. For example, such operation can include functionality in which, upon reception of wireless signals, the internal components detect communication signals and the transceiver 202 demodulates the communication signals to recover incoming information, such as voice and/or data, transmitted by the wireless signals. After receiving the incoming information from the transceiver 202, the processor 204 formats the incoming information for the one or more output devices 208. Likewise, for transmission of wireless signals, the processor 204 formats outgoing information, which may or may not be activated by the input devices 210, and conveys the outgoing information to one or more of the wireless transceivers 202 for modulation to communication signals. The wireless transceiver(s) 202 in turn convey the modulated signals by way of wireless and (possibly wired as well) communication links (again, such as the communication links 105, 110) to other devices such as the web server 104 and one or more of the CPWs 106 (as well as possibly to other devices such as a cell tower, access point, or another server or any of a variety of remote devices).

Depending upon the embodiment, the input and output devices 208, 210 of the internal components 200 can include a variety of visual, audio and/or mechanical outputs. For example, the output device(s) 208 can include one or more visual output devices 216 such as a liquid crystal display and light emitting diode indicator, one or more audio output devices 218 such as a speaker, alarm and/or buzzer, and/or one or more mechanical output devices 220 such as a vibrating mechanism. The visual output devices 216 among other things can include a video screen. Likewise, by example, the input device(s) 210 can include one or more visual input devices 222 such as an optical sensor (for example, a camera), one or more audio input devices 224 such as a microphone, and one or more mechanical input devices 226 such as a flip sensor, keyboard, keypad, selection button, navigation cluster, touch pad, touchscreen, capacitive sensor, motion sensor, and switch. Actions that can actuate one or more of the input devices 210 can include not only the physical pressing/actuation of buttons or other actuators, but can also include, for example, opening the mobile device, unlocking the device, moving the device to actuate a motion, moving the device to actuate a location positioning system, and operating the device.

As shown in FIG. 2, the internal components 200 of the mobile device 102 also can include one or more of various types of sensors 228. The sensors 228 can include, for example; proximity sensors (e.g., a light detecting sensor, an ultrasound transceiver or an infrared transceiver), touch sensors, altitude sensors, a location circuit that can include, for example, a Global Positioning System (GPS) receiver, a triangulation receiver, an accelerometer, a tilt sensor, a gyroscope, or any other information collecting device that can identify a current location or user-device interface (carry mode) of the mobile device 102. Depending upon the embodiment, certain types of devices can be classified as being among the sensors 228 or among the input devices 120, or both.

The memory portion 206 of the internal components 200 can encompass one or more memory devices of any of a variety of forms (e.g., read-only memory, random access memory, static random access memory, dynamic random access memory, etc.), and can be used by the processor 204 to store and retrieve data. The data that is stored by the memory portion 206 can include, but need not be limited to, operating systems, applications, and informational data. Each operating system includes executable code that controls basic functions of the communication device, such as interaction among the various components included among the internal components 200, communication with external devices via the wireless transceivers 202 and/or the component interface 212, and storage and retrieval of applications and data, to and from the memory portion 206. Each application includes executable code that utilizes an operating system to provide more specific functionality for the communication devices, such as file system service and handling of protected and unprotected data stored in the memory portion 206. Informational data is non-executable code or information that can be referenced and/or manipulated by an operating system or application for performing functions of the communication device.

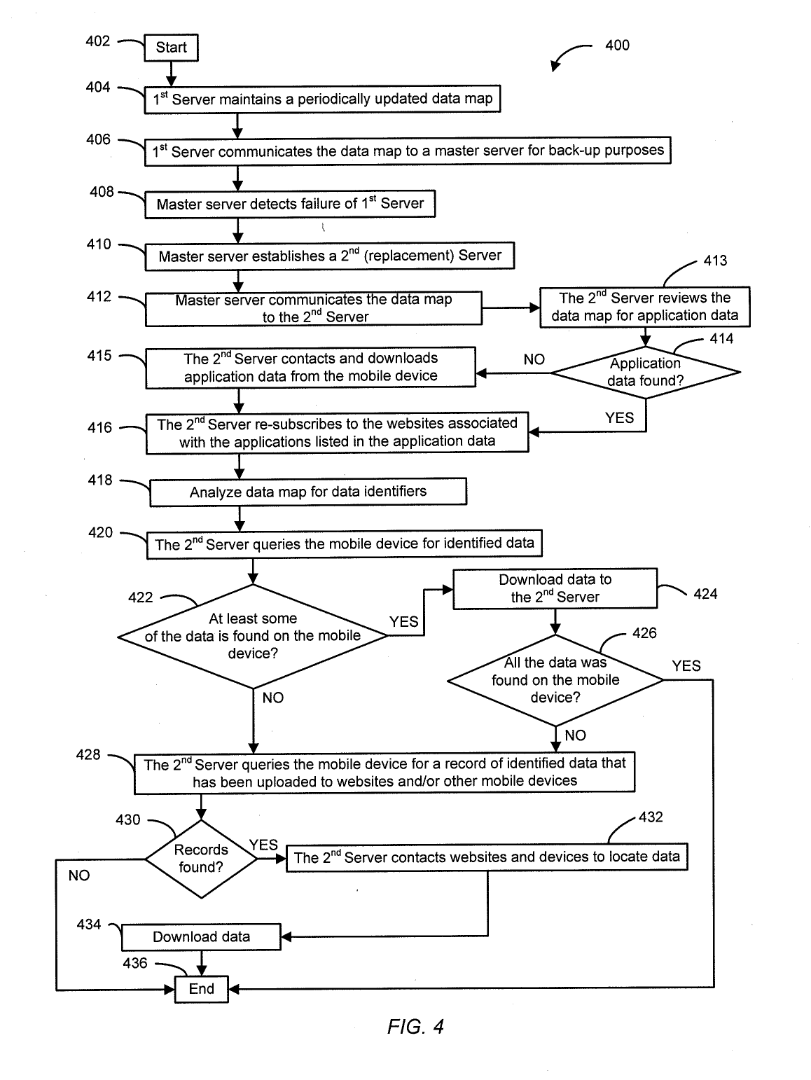

Referring next to FIG. 3, the web server 104 of FIG. 1 is shown in more detail. As shown, in the present exemplary embodiment, the web server 104 includes not merely a single server but rather is understood to encompass several servers. These can be located physically at substantially the same location or, alternatively, can be understood as being located respectively at different physical locations. In the present example, the web server 104 particularly includes a master server 300 and first and second slave servers 302 and 304, respectively, where any one or more (and possibly all) of the servers 300, 302, 304 are web-based. The master server 300 in at least some embodiments (e.g., such as that discussed further below with respect to FIG. 4) serves as a controller and data map storage point for the slave servers 302, 304. Also, in some embodiments, the master server 300 facilitates communications through one or more of the slave servers.

In at least some embodiments, the slave servers 302, 304 can operate with integrated controllers that facilitate communications into, out of, and in between the slave servers, thereby eliminating the need for any master server. Also, while in FIG. 3 the two slave servers 302, 304 are shown, in other embodiments only one slave server or more than two slave servers can be employed. Further, although not shown, it will be understood that in the present embodiment one or more of the servers 300, 302, 304 includes a memory portion and a processor portion in communication with that memory portion, and one or more input/output (I/O) interfaces for interfacing the communication links 105, 108 with the processor portions of the servers.

As discussed above with respect to FIG. 1, and as further shown in FIG. 3, in the present embodiment each of the mobile devices 102 is able to communicate with one or more of the CPWs 106 by interfacing with the web server 104, which serves as an intermediary between the mobile devices and the CPWs. More particularly, when one of the mobile devices 102 is conducting such communications, it utilizes one or more of the communication links 105 to connect to one or more of the slave servers 302, 304 that in turn is/are in communication with one or more of the CPWs by one or more of the communication links 108. Whether any given communication occurs by way of any given one of the slave servers 302, 304 is determined based upon which of the slave server(s) are assigned by the master server 300 for this purpose. That is, in the present embodiment, the master server 300 determines whether any given one or more of the slave servers 302, 304 is/are assigned for communications with any given one or more of the CPW(s) 106, independently or on behalf of one or more of the mobile devices 102, and/or determines whether any given one or more of the slave servers is/are assigned for communications with any given one or more of the mobile devices 102.

As further shown in FIG. 3, in addition to the slave servers 302, 304 being in communication with the mobile devices 102 and CPWs 106 via the communication links 105, 108, each of the slave servers is also in communication with the master server 300 by way of additional links 306. While the communication links 306 are intended to allow for bidirectional communications between the master server 300 and the slave servers 302, 304, in at least some other embodiments communication between the master and slave servers is uni-directional (master to slaves only, or slaves to master only). Also, while in the present exemplary embodiment the additional links 306 are shown to be dedicated links internal to the web server 104, it will be understood that in other embodiments the servers 300-304 can be in communication via any arbitrary communication links, including communication links that are physically external to the web server 104. Indeed, depending upon the embodiment, the additional links 306 can take any of the forms that can be taken by any of the communication links 105, 108 as described above. Thus, while the present embodiment envisions direct communications between the master server and the slave servers, in at least some other embodiments, communication between the master server and the slave servers is indirect (and thus there is no need for additional dedicated links 306).

Additionally, although it is envisioned that, typically, communications between the mobile devices 102 and the CPWs 106 via the web server 104 occur specifically via one or more of the slave servers 302, 304, as shown the master server 300 can also conduct communications with the mobile devices 102 and CPWs 106 via ones of the communication links 105, 108. Further, although such communications between the master server 300 and the mobile devices 102 need not involve (or be passed on to or be received from) the CPWs 106, and although such communications between the master server 300 and the CPWs need not involve (or be passed on to or be received from) the mobile devices 102, in some embodiments it is possible that the master server 300 also will facilitate communications between the mobile devices 102, and the CPWs 106.

Still referring to FIG. 3, in at least some embodiments the slave servers 302, 304 can access, upload, and download data (messages, files, etc.) to and/or from the various CPWs 106 and to and/or from the various mobile devices 102. In at least some such embodiments, the respective slave servers are subscribed (or pre-subscribed) to particular ones of the CPWs 106 for this purpose (which subscription can be on behalf of one or more of the mobile devices). In addition, each of the slave servers 302, 304 maintains a respective data map 308 that is periodically backed-up (depending upon the embodiment) to the master server 300 and/or to one or more of the mobile device(s) 102, where the data map can contain numerous pieces of information. Among other things, the data map can store records concerning any data transactions that occur between the mobile device(s) 102 and the CPWs 106 with which those mobile device(s) are in communication via the web server 104 and its internal servers 300, 302, 304.

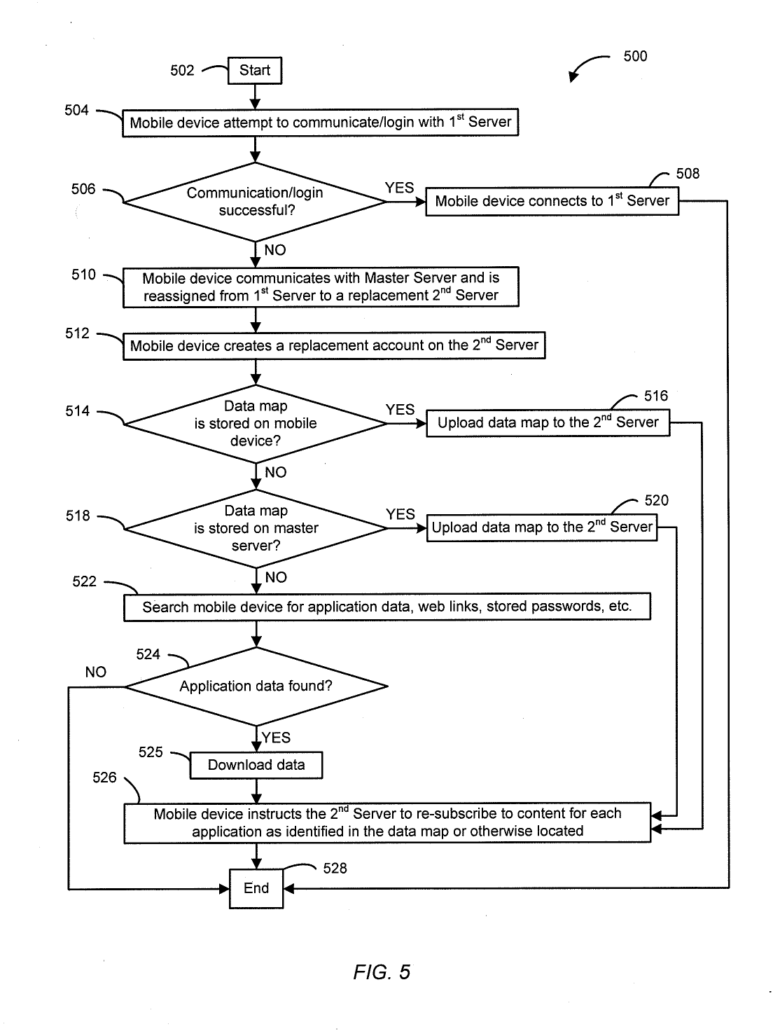

While as noted above in some embodiments the data maps 308 are periodically backed-up to the master server 300, in other embodiments the data maps are periodically instead (or also) backed up to one or more of the mobile devices 102. The contents of any given data map can vary depending upon whether the data map is backed-up to a master server such as the master server 300 or to one or more mobile device(s) such as the mobile device(s) 102. The backed-up data map information can later be used to assist in a server recovery, as discussed below with reference to FIGS. 4 and 5. In the above-described manner, therefore, a plurality of the mobile devices 102 can be in communication with the web server 104 at any given time, using one or more of the slave servers 302, 304 to process the communications and establish data maps for each of the mobile devices 102, with the data maps being backed-up at the master server 300 and/or one or more of the mobile devices.

Referring to FIG. 4, an exemplary flowchart 400 is provided showing exemplary steps of operation performed by the web server 104 of FIG. 3 that allow for the retrieval of data after a failure event has occurred. As shown, once the process has begun at a step 402, as represented by a step 404 a first slave server such as the slave server 302 of FIG. 3 maintains and stores a periodically-updated data map. Further, at a step 406, the data map maintained by the first slave server 302 is periodically communicated to the master server 300 for storage. In at least some alternate embodiments, the data map is also (or instead) communicated to appropriate one(s) of the mobile devices 102 as well. The data map can include, in at least some embodiments, an aggregated listing of files and messages that have been accessed, uploaded and downloaded between one or more of the mobile devices 102 and one or more of the CPWs 106 by way of the first slave server 302. The data map can further include a record of the destinations or sources that files and messages were transferred to or from (including links such as hyperlinks to web pages), thereby providing a record of locations at which those files or messages would most likely still reside at later times. The locations can include one or more of numerous networks, for example, the internet, a LAN, and a cellular network (where the data is stored on other mobile devices), or locations in relation thereto.

For example, supposing that a series of photos is uploaded at a given time from one of the mobile devices 102 to a social networking website page associated with one of the CPWs 106 using the first slave server 302, then the data map stored at the first slave server and communicated (copied) to the master server 300 (or to that mobile device or other(s) of the mobile devices 102) can include the file names of the photos and the destination address of the website page (or link) to which those photos were uploaded. Additionally for example, if a user transfers a song from a first of the mobile devices 102 to a second of the mobile devices 102 via the first slave server 302 of the web server 104, then the data map stored at the first slave server and communicated to the master server 300 can include the song title as well as the link identifying the transfer to the second mobile device. In such embodiments, by storing at the web server 104 the destination address of the website page or the address/identity of the second mobile device that received the song, the web server 104 therefore has in its possession information, regarding the last known locations of those items. Further, in at least some other embodiments the data map can include a listing of applications a user is subscribed to along with the associated web links (or other links), passwords or other types of application data, which can be utilized as discussed below.

Further as shown in FIG. 4, next at a step 408, if a failure occurs with respect to the first slave server 302, the master server 300 detects that failure. Such a failure can be detected in one or more manners depending upon the embodiment. For example, in some embodiments, the master server 300 is able to detect such a failure by way of an alarm that is automatically provided by a slave server when it experiences a failure, or based upon a failure of the slave server to respond in an expected manner to check signals sent by the master server to the slave server as part of periodic or otherwise routine checking performed by the master server. Further for example, in one embodiment, upon a failure occurring in the first slave server 302, the master server can receive an indication from one of the mobile devices 102 that has been in communication with the first slayer that an attempt by that mobile device to access the first slave server has failed. In such an embodiment, the mobile devices 102 can be programmed to automatically provide such messages to the master server 300 after a period of time of not being able to access a slave server.

Upon detection of the failure of the first slave server 302 at the step 408, the master server 300 identifies or determines another server such as the second slave server 304 at a step 410 that can serve as a replacement server, and establishes the second slave server as the replacement server. Establishment of the second slave server 304 (or another server) as the replacement server can be understood to involve preliminarily configuring the second slave server for operation as the replacement server. Notwithstanding such preliminary configuration, the second slave server 304 cannot ultimately operate as a replacement server for the first slave server 302 that has failed, unless and until the second slave server achieves storage of the same data (or at least appropriate portions of the same data) that was stored at the first slave server at, or just prior to, the time of the failure of the first slave server. In the present embodiment, the second slave server 304 achieves this status by recovering information found in one or more other locations, such as in back-up files, on associated mobile devices, on network sites, on websites, and on other devices with which the associated mobile devices have been in communications.

More particularly in this regard, at a step 412, the master server 300 communicates the data map that has been stored at the master server (as provided by the first slave server 302) to the second slave server 304 that has been established as the replacement server. At step 413 the second slave server 304 reviews the data map for application data. The application data in particular can include information that is indicative of particular application(s) that were being used by one or more the mobile devices 102 for communication purposes (e.g., for the purpose of communicating with one or more of the CPWs 106) by way of the first slave server 302 when the failure in the first slave server occurred. If application data is found at a step 414, then at a step 416 the second slave server 304 uses the application-related data to restore previously-existing communications with the mobile devices 102 to which that application-related data pertained. For example, in at least some such circumstances, that application-related data allows one or more of the mobile device(s) 102 to re-subscribe to one or more of the CPWs 160 identified in the application-related data, thereby allowing for direct communication to be restored between mobile device(s) 102 and the CPW(s) 106 by way of the second slave server 304. Alternatively, if application data is not found at the step 414, then at a step 415 the second slave server 304 contacts the mobile device 102 and downloads the application-related data from the mobile device 102. Once such application-related data is downloaded, then the second slave server 304 can again advance to, and perform, the step 416. Although not shown in FIG. 4, in another embodiment, a data map is empty or is not at all present. In such an embodiment, a number of the steps subsequent to the step 410 need not be present (e.g., the process could skip from the step 410 to a step 420 discussed below).

Upon completion of the step 416, at a step 418 the second slave server 304 analyzes the data map. In this regard, among other things, the second slave server 304 searches for specific data identifiers, such as file/message names and/or associated file/message upload and download paths, etc. Typically, at least some data identifiers will be found. Then at the step 420, the second slave server 304 queries the mobile device(s) 102 to locate any of the data identified by the data identifiers found in step 418. (In the case where no data identifiers were found, the mobile device can be queried for all data.) Any arbitrary number of the mobile devices 102 can be queried in this regard, depending upon the embodiment or circumstance. Next, at a step 422, if the second slave server 304 detects that at least some of the identified data is in fact located on the mobile device(s) 102, then the data is subsequently downloaded at a step 424 to the second slave server 304. Further, at a step 426, if the second slave server 304 detects that all of the identified data was located on the mobile device(s) 102 and downloaded successfully, then the process is completed, and advances to an end step 436.

Alternatively, if at the step 422 it is determined that none of the identified data is found at the mobile device(s) 102 or, if at the step 426 it is determined that only a portion of the identified data was found at the mobile device(s) 102, then the process instead advances to a step 428. At the step 428, the second slave server 304 queries the mobile device(s) 102 for one or more records of any of the identified data that was uploaded to any of the CPWs 106 or to another device (such as other(s) of the mobile device(s) 102). Such uploading can have occurred via the web server 104 (e.g., via the first slave server 302) or perhaps independently of the web server. If, in response to the queries of the step 428, communication records are found on the mobile device(s) 102 and received back at the second slave server 304 at a step 430, then at a step 432 the second slave server contacts the CPW(s) or other device(s) identified in the records so as to locate the data, and at a step 434 such located data is then ultimately downloaded to the second slave server 304 from the CPW(s) or other device(s). Upon completion of the step 434 or, alternatively, if no records are found in the step 430, then the process jumps to the end step 436.

It should be mentioned that, in at least some embodiments, the web server 104 is configured to facilitate a recovery of a failed slave server with minimal input required from the user(s) of the mobile device(s) 102. Indeed, in at least one embodiment, the recovery can take place without any interaction whatsoever from any mobile device user(s), as each of the mobile device(s) 102 (and any other network components such as the CPWs 106) can be contacted automatically without the knowledge or involvement of any user(s) of the mobile device(s). From the above description, it should be evident that a replacement server such as the second slave server 104 depending upon the embodiment can be populated with recovered information by contacting any appropriate number of the mobile device(s) 102 and/or CPW(s) 106 (and/or possibly other device(s)). For example, while in some cases only a single one of the mobile devices 102 and/or a single one of the CPW(s) 106 will be consulted, in other embodiments several mobile devices and/or several CPWs (or other devices) will be consulted.

Although the exemplary flowchart 400 illustrates operations governed by the web server 104 (and especially the master server 300) in achieving a recovery of data after a failure event has occurred, in other embodiments server restoration operations can be governed (or at least prompted) by a given one or more of the mobile device(s) 102. Turning to FIG. 5, an exemplary flowchart 500 is provided that shows various steps of operations of one of the mobile devices 102 in this regard. As shown, upon the process starting at a step 502, at a step 504 the mobile device 102 attempts to login/connect to one of the slave servers 302, 304 of the web server 104, which in this embodiment is the first slave server 302. The first slave server 302 in this example, can have been assigned by the web server 104 (and potentially by the master server 300) to facilitate communications between the aforementioned one mobile device and one or more of the CPW(s) 106.

At a step 506 the mobile device 102 further detects if a successful login has been made in relation to the first slave server 302. If the login is successful, then the process proceeds to a step 508 with the mobile device 102 being connected to the first slave server 302 as expected, and accordingly the process then advances to an end step 528 (after which normal communications between the mobile device and that slave server can occur). However, if the login attempt to the first slave server 302 fails, then instead of proceeding to the step 508 the process rather advances to a step 510. At the step 510, the mobile device 302 communicates the failure to the master server 300, such that the master server is directed to initiate a recovery protocol. As further indicated by the step 510, the recovery protocol, when executed by the master server 300, causes the mobile device 102 to be reassigned from the first slave server 302 to another slave server that is an active, functional server, for example, the second slave server 304.

Once the mobile device 102 has been reassigned, the mobile device 102 and/or master server 300 initiate the establishment of a replacement account on the second slave server 304 during a step 512. The replacement account is intended to replicate, in terms of the data stored in the replacement account, the contents of the account of the slave server that has experienced the failure (that is, in this embodiment, the first slave server 302) as it was at the time of, or just prior to, the failure. Such replication can be achieved by obtaining information found in various places, such as in a data map, at one or more of the mobile devices 102, at one or more network sites or websites including one or more of the CPWs 106, and at one or more other devices, some of which may have been directly or indirectly in communications with the mobile device 102 that has been reassigned to the second slave server 304.

More particularly, upon creation of the replacement account at the second slave server 304, additional steps 514-536 are performed in an effort to rebuild the data that was present on the first slave server 302. The rebuilding begins at a step 514 in which the second slave server 304 checks with that one of the mobile devices 102 that initiated the process to determine whether a data map is stored on that mobile device. Such a data map can take the same or similar form as that discussed above with respect to FIG. 4. If a data map is found on that one of the mobile devices 102 that initiated the process, then the data map is uploaded to the second slave server 304 at a step 516 and the process then jumps to a step 526. Alternatively, if a data map is not found on the mobile device 102 that initiated the process, then the process instead advances to a step 518, at which the second slave server 304 instead communicates with the master server 300 to check whether a data map was stored at the master server. If a data map is found on the master server 300, it is uploaded to the slave server 304 at a step 520, and the process again jumps to the step 526. In at least one embodiment, a data map such as those uploaded in the steps 516 and 520 includes and maintains an aggregate listing of the current information available on the subscribed-to accounts.

If no data map was found as a result of the performing of both of the steps 514 and 518, then at a step 522 the second slave server 304 contacts that one of the mobile devices 102 that initiated the process for a listing of application data stored on that mobile device. Such application data can include, for example, active applications and their associated web links and/or passwords (or hints or cues) that can be stored on the mobile device 102. Such data can potentially be used to enable the second slave server 304 to locate lost content, and/or re-subscribe to those applications that were previously subscribed to by the first slave server 302, thereby allowing the second slave server to reestablish access to associated content without the need for a user to manually re-subscribe to each application. If such application data cannot be located at the step 524, then the process can advance to the end step 528, since in such case it may not be possible for the replication process to be completed in relation to the second slave server 304. In at least some embodiments, at such time a message can be sent to the user of the mobile device 102 that initiated the process that the second slave server 304 is unable to re-establish the account of the first slave server 302. If alternatively at the step 524 application data is found on the mobile device 102 that initiated the process, then such information is downloaded to the second slave server 304 at a step 525.

After the downloading in the step 525 is complete, then the process advances to the step 526, as is also the case upon the completion of either of the steps 516 and 520 discussed above. Upon arriving at the step 526, the second slave server 304 is in possession of either application data from the mobile device 102 that initiated the process, or in possession of a data map provided by either that mobile device or the master server 300. Given this to be the case, at the step 526, the mobile device 102 that initiated the process further instructs the second slave server 304 to re-subscribe to the appropriate content associated with each application as identified in the data map or otherwise located, and in response to this instruction from the mobile device, the second slave server obtains the content associated with each known application in accordance with the application data. It at least some circumstances, the application data allows the second slave server 304 to identify and login to one or more of the CPW(s) 106, and to access the information from those CPW(s) that was previously made available to the first slave server 302 prior to its failure. From the above description, it should be evident that the present invention is intended to encompass a variety of processes and methodologies allowing for the recovery of data that was formerly stored at a server (which can also be viewed as a resyncing process), where the server has experienced a failure such that the data was no longer available from the server. In at least some embodiments, the data formerly at the server can be reassembled, at a different server (or even potentially at the same server if that server becomes operational again), by obtaining portions of the lost information from one or more mobile devices, one or more other servers, and/or one or more content provider websites. Also, in at least some embodiments, the data is reassembled partly based upon a data map or other structure stored at location(s) other than the server experiencing the failure (e.g., at a mobile device or a master server), where the data map or other structure, even though not including all of the lost content/data, stores application data, links, passwords, or other cues or hints that are indicative of what the lost content/data was and/or where some or all of that lost content/data can be found, and or allows for accessing of the lost content/data.

Although the above-described embodiments describe certain exemplary steps of operation, the present invention is intended to encompass other embodiments in which only some of these steps are performed, where additional steps are also performed; and/or where one or more of these steps are performed in different orders than as discussed above. For example, notwithstanding the above description, in another embodiment, in the event no data map is found on the mobile device at the step 514, the process immediately advances to the step 522 (that is, the steps 518 and 520 involving the master server are not performed). While in some embodiments the recovery process can be governed entirely or primarily by a given mobile device or a given server (which can be, but need not be, a master server), in other embodiments the process can be achieved in a more collaborative manner among various devices. Also, while in some embodiments some types of information are stored at CPW(s) and can only be reobtained after a log-in process has been performed, in other embodiments the information can be reobtained without any log-in process required. The exact numbers mobile devices, servers, CPWs and/or other devices involved in the process can vary depending not only upon the particularly system features but also upon the operational circumstance.

Indeed, different embodiments of the present invention and/or different manners of operation are applicable to different operational scenarios. In scenarios where a complete data center recovery is required (e.g., where all or substantially all data is lost), all mobile devices (and associated users) that were in communication with the data center before its failure will typically re-create their accounts in the datacenter following the failure. As part of the account creation process, the server being recreated is able to read data off the users' mobile devices and to repopulate the datacenter. In some cases, a user who has lost his password can create a new account, and load the data already in his phone back up into that account. This again permits the use of the devices as distributed recovery mechanism.

Alternatively, in other scenarios, account information continues to be stored in a conventional manner (e.g., by way of conventional backup systems, which can be in the form of the master server discussed above) but the remainder of the data is stored on the mobile devices. In such scenarios, even thought for each mobile device there is potentially a great deal of data to be stored, this data is not subject to being lost when the data center failure occurs. Rather, only a small amount of data (which constitutes only a small subset of the all of the data including that stored at the mobile devices) is stored in the datacenter. In at least some such schemes, user credentials are protected by a conventional datacenter backup strategy, while the mobile devices re-populate the rest of the user data. This scheme makes the experience more user friendly, while keeping the same main thrust.

In additional scenarios, there can be data, for example videos and photos that are too large (in terms of the amount of data being stored) to be appropriately stored on a mobile device. Such data can still be stored at the data center even though such data may be lost in the case of a data center failure (regardless of 1 or 2 being implemented) because the data is not stored on the mobile device. Backup storage for such information in such scenarios can again be protected by conventional data backup devices.

It is specifically intended that the present invention not be limited to the embodiments and illustrations contained herein, but include modified forms of those embodiments including portions of the embodiments and combinations of elements of different embodiments as come within the scope of the following claims.

We claim:

1. A method of recovering data lost by a first server, the method comprising:
(a) receiving a data map pertaining to the lost data from one or both of a second server and a first mobile device;
(b) obtaining application data from the data map; and
(c) based upon the application data, accessing one or more of the first mobile device, a second mobile device and a content provider website to obtain at least some of the lost data.

2. The method of claim 1, wherein the application data includes account information for logging into the content provider website.

3. The method of claim 2, wherein the content provider website is a social networking website, and wherein at least some of the lost data is obtained from the social networking site.

4. The method of claim 1, wherein the application data includes at least one of a link, a password, a cue and a hint indicative of a location of at least some of the lost data or allowing for access to the lost data.

5. The method of claim 1, wherein the data map includes an aggregated listing of files that have been at least one of accessed by, uploaded from, and downloaded to, one or more mobile devices including one or both of the first mobile device and a second mobile device.

6. The method of claim 1, wherein the data map includes a record of at least one of communication pathways, web links or sources that files were transferred to and/or from the mobile device.

7. The method of claim 1, wherein the data map and the lost data are obtained by a replacement server differing from the first server and the second server.

8. The method of claim 7, further comprising:
(d) searching the data map for data identifiers; and
(e) querying one or both of the first mobile device and the second mobile device for data files identified by the data identifier; and
(f) downloading one or more of the data files, when found, to the replacement server.

9. The method of claim 8, further comprising:
(f) querying one or both of the first and second mobile devices for records relating to communications of one or more of the data files or additional data files between one or more additional devices and one or both of the first and second mobile devices;
(g) obtaining one or more of the data files, or one or more of the additional files, from one or more of the additional devices.

10. The method of claim 1, wherein the data map is received at a replacement server from the second server, which is a master server, and wherein each of a replacement server and the master server is a portion of a web server.

11. The method of claim 1, wherein the data map is received at a replacement server from the second server, which is a master server, and wherein the master server previously received the data map from the first server.

12. The method of claim 1, wherein the mobile device includes at least one of a cellular telephone, personal digital assistant, and a laptop.

13. A method of facilitating a recovery of data lost by a first server, the method comprising:
(a) detecting a failure in the first server;
(b) taking an action that precipitates reassignment of a responsibility of the first server to a second server; and
(c) causing transmission of a data map to the second server,
whereby the transmission of the data map to the second server allows the second server to conduct additional communications by which the data lost by the first server is recovered by the second server.

14. The method of claim 13, wherein the method is performed by an additional server.

15. The method of claim 14, wherein the additional server is a master server, and wherein the data map was received by the master server from the first server prior to the failure.

16. The method of claim 13, wherein the method is performed by a mobile device, wherein the mobile device detects the failure upon an occurrence of a failed attempt at logging into the first server, and wherein the action of the mobile device involves sending a message to a master server that in turn causes the master server to create a replacement account on the second server and to reassign the responsibility for the mobile device from the first server to the second server.

17. The method of claim 16, wherein (c) includes either (i) sending the data map from the mobile device to the second server, or (ii) causing the master server to send the data map to the second server.

18. The method of claim 13, wherein the method is performed by the mobile device, and wherein the mobile device further sends one or more of application data and identified data to the second server upon receiving a request from the second server.

19. A system for recovering data lost by the first server upon an occurrence of a failure event, the system comprising:
a second server having at least one interface by which the second server is able to communicate with one or more of a mobile device and a content provider website; and
a third server in communication with the second server, wherein the third server stores a data map pertaining to the data,
wherein, upon receiving an indication of the occurrence of the failure event, the third server determines that the second server should store the data when recovered and then additionally provides the data map to the second server, and
wherein, upon receiving the data map, the second server based upon the data map contacts the mobile device or the content provider website to obtain the data lost by the first server.

20. The system of claim 19, wherein the second and third servers are comprised by an overall web server, wherein the third server is a master server, wherein the data map is received by the third server from one of the first server and the mobile device, and wherein the data map includes one or more of application data, links, passwords, cues, or hints indicative of one or more locations or characteristics of the data lost by the first server or allowing access to the data lost by the first server.
